(19) United States
(12) Patent Application Publication
(10) Pub. No.: US 2008/0019604 A1
(43) Pub. Date: Jan. 24, 2008

(54) METHOD FOR DYNAMIC IMAGE PROCESSING AND DYNAMIC SELECTION MODULE FOR THE SAME

(75) Inventors: Zhen-Yong Gao, Taipei (TW); Wan-Duo Wang, Taipei (TW); Jiunn-Shyang Wang, Taipei (TW); Seng-Che Tsao, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA TECHNOLOGIES, INC., Taipei (TW)

(21) Appl. No.: 11/760,053

(22) Filed: Jun. 8, 2007

(30) Foreign Application Priority Data
Jul. 21, 2006 (TW) 95126700

(51) Int. Cl. G06K 9/40

(52) U.S. Cl. 382/260

(57) ABSTRACT

The invention provides a method for dynamically processing an image. In an exemplary embodiment, the image comprises a plurality of pixels. First, a value of a target pixel of the pixels is subtracted from values of surrounding pixels of the target pixel to obtain a plurality of difference values. A plurality of absolute values of the difference values is then calculated. The absolute values are then summed to obtain an accumulation value. The accumulation value is then compared with N reference values to select a target interval corresponding to the accumulation value. A filter coefficient set corresponding to the target interval is then determined. Finally, the target pixel is filtered according to the filter coefficient set.

### BACKGROUND OF THE INVENTION

1. Field of the Invention

The invention relates to image processing, and more particularly relates to select filter coefficient for image processing.

2. Description of the Related Art

FIG. 1 is a block diagram of a conventional image processor. The conventional image processor includes an image input module 10, a transmission interface 11, and an image processing module 12. An image is delivered to the image processing module 12 through the image input module 10. A central processing unit 13 sends a filter coefficient set Pf to the image processing module 12 via the transmission interface 11, and the image processing module 12 processes the image according to the filter coefficient set to obtain a filtered image.

The central processing unit 13 determines the filter coefficient set Pf according to a datastream comprising image information. Because the image processing module 12 processes images according to the same filter coefficient set in a fixed time, the images cannot be filtered according to the characteristics thereof if the filter coefficient set is not changed, it would have negative affection on the final quality of the filtered images. For example, if a portion of an input image should be blurred, and the other portion should be clarified, but the image processing module 12 uses only a smoothing filter coefficient set, the entire filtered image is blurred or clarified and cannot meet all the filtration requirements.

Additionally, errors may occur in the datastream such that information therein is wrong, inducing an erroneous filter coefficient set generated by the center processing unit 13. The image processing module 12 processes an input image according to the erroneous filter coefficient set, and a poor filtered image is obtained.

### BRIEF SUMMARY OF THE INVENTION

The invention provides a dynamic selection module, dynamically determining a filter coefficient set for filtering an input image which comprises a plurality of pixels. In an exemplary embodiment, the dynamic selection module comprises a calculation unit, a comparison unit, and a selection unit. The calculation unit subtracts a value of a target pixel of the pixels from values of surrounding pixels of the target pixel to obtain a plurality of difference values, calculates a plurality of absolute values of the difference values, and sums the absolute values to obtain an accumulation value. The comparison unit then compares the accumulation value with N reference values to obtain a comparison result. Finally, the selection unit determines the filter coefficient set corresponding to a target interval selected from (N+1) intervals delimited by the N reference values. The target pixel is then filtered according to the filter coefficient set.

The invention also provides a method for dynamically processing an image. In an exemplary embodiment, the image comprises a plurality of pixels. First, a value of a target pixel of the pixels is subtracted from values of surrounding pixels of the target pixel to obtain a plurality of difference values. A plurality of absolute values of the difference values is then calculated. The absolute values are then summed to obtain an accumulation value. The accumulation value is then compared with N reference values to select a target interval corresponding to the accumulation value. A filter coefficient set corresponding to the target interval is then determined. Finally, the target pixel is filtered according to the filter coefficient set.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional image processor;

FIG. 2 is a block diagram of an image processor according to the invention;

FIG. 3 is a block diagram of a dynamic selection module according to the invention;

FIG. 4a shows a square area including 9 pixels of an input image;

FIG. 4b shows an exemplary embodiment of the (N+1) intervals delimited by the N reference values;

FIG. 5 is a detailed block diagram of a dynamic selection module according to the invention; and

FIG. 6 is a flowchart of a method for dynamically processing pixels of an input image according to the invention.

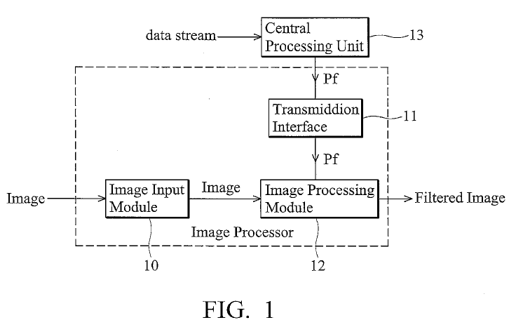

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

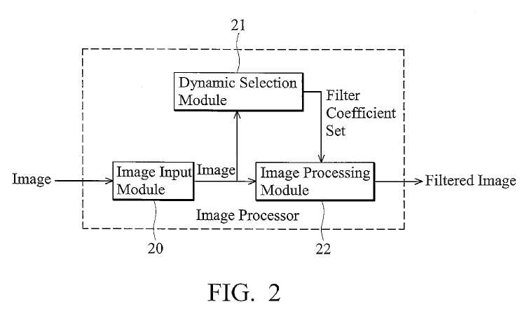

FIG. 2 is a block diagram of an image processor according to the invention. The image processor includes an image input module 20, a dynamic selection module 21, and an image processing module 22. An image is delivered to the dynamic selection module 21 and the image processing module 22 through the image input module 20. The dynamic selection module 21 dynamically selects a filter coefficient set according to the image and sends the selected filter coefficient set to the image processing module 22. The image processing module 22 then processes the image according to the selected filter coefficient set to obtain a filtered image. In one embodiment, the image processor is implemented with a digital logic circuit.

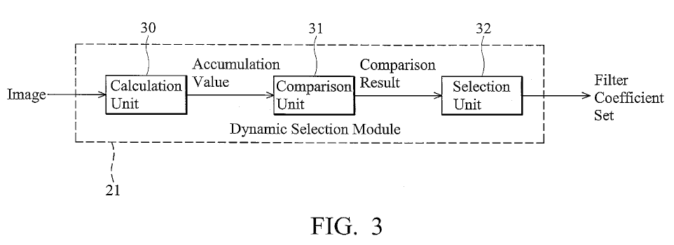

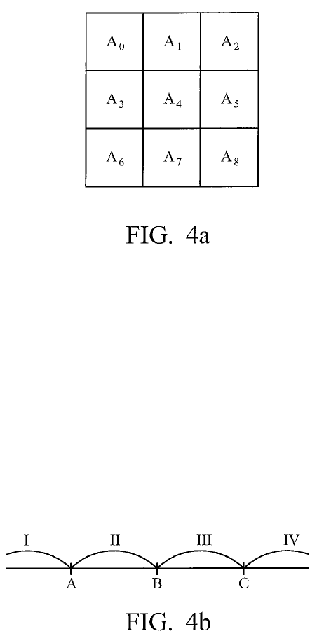

FIG. 3 is a block diagram of a dynamic selection module according to the invention. The dynamic selection module 21 dynamically generates a filter coefficient set according to a input image. The input image comprises a plurality of pixels, wherein each pixel corresponds to a pixel value. In one embodiment, the pixels may be red, blue, or green. The dynamic selection module 21 includes a calculation unit 30, a comparison unit 31, and a selection unit 32. When the image processing module processes a value of a target pixel of the input image, the calculation unit 30 respectively subtracts values of surrounding pixels from the target pixel value to obtain a plurality of difference values, then calculates the absolute values of the difference values, and then sums the absolute values to obtain an accumulation value. FIG. 4a shows a square area including 9 pixels A0˜A8 of an input image. When the image processor is to process a target pixel A4, the calculation unit 30 subtracts values of surrounding pixels A0˜A3 and A5˜A8 from the value of the target pixel A4 to obtain eight difference values, then calculates eight absolute values of the difference values, and then sums the eight absolute values to obtain an accumulation value.

Referring to FIG. 3. After the calculation unit 30 obtains the accumulation value, the comparison unit 31 compares the accumulation value with N reference values to obtain a comparison result outputs to the selection unit 32, wherein the comparison result may be a series of bits. The selection unit 32 then selects a target interval corresponding to the accumulation value from (N+1) intervals delimited by the N reference values according to the comparison result, and determines a filter coefficient set corresponding to the target interval as the output. The N reference values are permuted in a magnitude order, and (N−1) intervals are delimited by pairs of adjacent reference values of the N reference values. The intervals exceeding a largest reference value and less than a smallest reference value are another two intervals in addition to the (N−1) intervals, and a total of (N+1) intervals is obtained. Each of the (N+1) intervals has a corresponding filter coefficient set.

FIG. 4b shows an exemplary embodiment of the (N+1) intervals delimited by the N reference values. If there are three reference values A, B, and C and N is 3, four intervals are obtained. The interval less than the smallest reference value A is interval I, and the interval exceeding the largest reference value C is interval IV. The intervals II and III are respectively delimited by the reference values A and B and the reference values B and C. The intervals I and II respectively correspond to different smooth filter coefficient sets. For examples, the filter coefficient set corresponding to the interval I includes filter coefficients of { 1/9, 1/9, 1/9, 1/9, 1/9, 1/9, 1/9, 1/9, and 1/9}, which respectively correspond to pixels A0˜A8 of FIG. 4a. The filter coefficient set corresponding to the interval II includes filter coefficients of { 1/16, 1/16, 1/16, 1/16, ½, 1/16, 1/16, 1/16, and 1/16}, which respectively correspond to pixels A0˜A8 of FIG. 4a. The smooth filter coefficient set of the interval I can better smooth an input image than the smooth filter coefficient set of the interval II. The intervals III and IV respectively correspond to different sharpness filter coefficient sets. The sharpness filter coefficient set of the interval IV can better sharpen an input image than the sharpness filter coefficient set of the interval III.

For example, if the selection unit 32 receives an accumulation value falling into the interval I, the input image may be a fractional image and not suitable for sharpness filtration to strengthen the image fracture. Thus, the selection unit 32 determines the smooth filter coefficient set corresponding to the interval I as the output filter coefficient set to smooth the fractional image. Otherwise, if the selection unit 32 receives an accumulation value falling into the interval IV, the input image may be blurred and not suitable for smooth filtration to strengthen the image blur. Thus, the selection unit 32 determines the sharpness filter coefficient set corresponding to the interval IV as the output filter coefficient set to sharpen the blurred image. Thus, the selection module 32 determines a filter coefficient set according to the interval corresponding to the accumulation value to achieve a better image filtration effect.

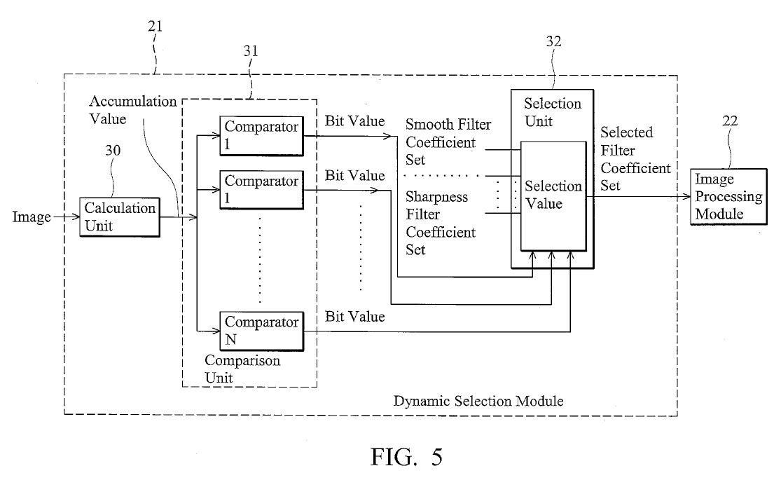

FIG. 5 is a detailed block diagram of a dynamic selection module 21 according to the invention. A comparison unit 31 includes comparators 1˜N, each of which corresponds to one of N reference values. If an accumulation value exceeds the reference value corresponding to a comparator, the comparator outputs a first bit value, such as 0. Otherwise, if the accumulation value is less than the reference value corresponding to the comparator, the comparator outputs a second bit value, such as 1. Thus, the comparators 1˜N output N bits, which are delivered to a selection unit 32. The selection unit 32 then generates a selection value according to the series of bits generated by the comparators to determine into which of (N+1) intervals the accumulation value falls, and then determines a filter coefficient set according to the selection value, wherein different selection values correspond to different intervals. Thus, the selection unit 32 can select a filter coefficient set output to the image processing module 22.

For example, a selection value of 3 corresponds to an interval III ranging between the reference values 2 and 3, and the interval III corresponds to a smooth filter coefficient set. A selection value of 4 corresponds to an interval IV exceeding the reference value 3, and the interval IV corresponds to a sharpness filter coefficient set. If the number N of reference values is 3, the comparators 1˜3 respectively compare the accumulation value with reference values 1, 2, and 3 thereof. Thus, if the accumulation value is 2.5, the comparators 1, 2, and 3 respectively generate bit values 0, 0, and 1 to form a comparison result. The selection unit 32 then generates a selection value 4 according to the comparison result comprising a series of bits {0, 0, 1}, because the selection value 4 is equal to [(0)×0+(0)×2+(1)×4]. Because the selection value 4 corresponds to the interval IV exceeding the reference value 3, the selection unit 32 selects a sharpness filter coefficient set corresponding to the interval IV as an output to the image processing module 22.

The image processing module 22 filters pixels of an input image according to the received filter coefficient set to obtain filtered pixels. Referring to the example of FIG. 4a, if the image processing module 22 receives a sharpness filter coefficient set including the values of {0, −1, 0, −1, 5, −1, 0, −1, 0} respectively corresponding to the pixels A0˜A8 of FIG. 4a, the image processing module 22 respectively multiplies the pixels A0˜A8 by the corresponding values of the sharpness filter coefficient set to obtain multiple products, and then sums the products to obtain the filtered pixel A4′. The filtered pixel A4′ is therefore equal to [(0×pixel A0)+(−1×pixel A1)+(0×pixel A2)+(−1×pixel A3)+5×(pixel A4)+(−1×pixel A5)+(0×pixel A6)+(−1×pixel A7)+(0×pixel A8)]. Otherwise, if the image processing module 22 receives a smooth filter coefficient set including the values of { 1/9, 1/9, 1/9, 1/9, 1/9, 1/9, 1/9, 1/9, 1/9}, the filtered pixel A4′ is equal to [(( 1/9)×pixel A0)+(( 1/9)×pixel A1)+(( 1/9)×pixel A2)+(( 1/9)×pixel A3)+(( 1/9)×pixel A4)+(( 1/9)×pixel A5)+(( 1/9)×pixel A6)+(( 1/9)×pixel A7)+(( 1/9)×pixel A8)].

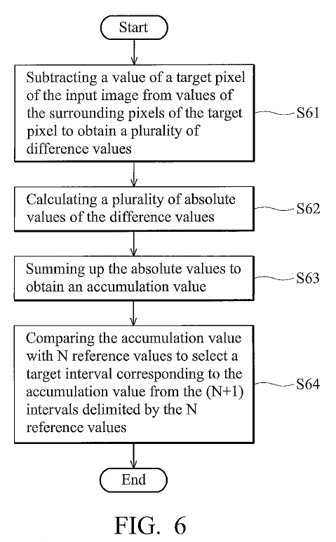

FIG. 6 is a flowchart of a method for dynamically processing determining pixels of an input image according to the invention. First, a value of a target pixel of the input image is subtracted by values of the surrounding pixels of the target pixel to obtain a plurality of difference values in step S61, as previously described in the embodiment of FIG. 4a. A plurality of absolute values of the difference values are then calculated in step S62. The absolute values are then summed to obtain an accumulation value in step S63. The accumulation value is then compared with N reference values in step S64 to select a target interval corresponding to the accumulation value from the (N+1) intervals delimited by N reference values, wherein each of the (N+1) intervals corresponds to a filter coefficient set.

The invention provides an image processor which dynamically selects filter coefficients according to pixels of an input image and then processes pixels of the input image according to the selected filter coefficients. Thus, the filter coefficients are dynamically adjusted according to characteristics of the input image to achieve better filtration effect.

In one embodiment of the invention, the accumulation value is compared with each of the reference values to find the interval corresponding to the accumulation value. The accumulation value is compared with N reference values to obtain a comparison result of N bits. A selection value is determined according to the N bits of the comparison result, and a filter coefficient set is selected according to the selection value. Thus, a filter coefficient set is selected according to an interval corresponding to the accumulation value in step S64. Finally, a target pixel and surrounding pixels are weighted according to coefficients of the selected filter coefficient set to obtain a filtered pixel.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dynamic selection module which dynamically determines a filter coefficient set for filtering an input image which comprises a plurality of pixels, comprising:
a calculation unit, subtracting a value of a target pixel of the pixels from values of surrounding pixels of the target pixel to obtain a plurality of difference values, calculating a plurality of absolute values of the difference values, and summing the absolute values to obtain an accumulation value;
a comparison unit, comparing the accumulation value with N reference values to obtain a comparison result; and
a selection unit, determining the filter coefficient set corresponding to a target interval selected from (N+1) intervals delimited by the N reference values;
wherein the target pixel is further filtered according to the determined filter coefficient set.

2. The dynamic selection module as claimed in claim 1, wherein the comparison unit includes N comparators generating N bit values making up the comparison result.

3. The dynamic selection module as claimed in claim 2, wherein if the accumulation value exceeds reference values corresponding to the comparators, the comparators output a first bit value, otherwise the comparators output a second bit value.

4. The dynamic selection module as claimed in claim 1, wherein the selection unit generates a selection value according to a series of bit values and then determines the filter coefficient set according to the selection value.

5. The dynamic selection module as claimed in claim 4, wherein the series of bit values are the comparison result generated by the comparison unit.

6. A method for dynamically processing an image, wherein the image comprises a plurality of pixels, the method comprising:
subtracting a value of a target pixel of the pixels from values of surrounding pixels of the target pixel to obtain a plurality of difference values;
calculating a plurality of absolute values of the difference values;
summing the absolute values to obtain an accumulation value;
comparing the accumulation value with N reference values to select a target interval corresponding to the accumulation value;
determining a filter coefficient set corresponding to the target interval; and
filtering the target pixel according to the filter coefficient set.

7. The method as claimed in claim 6, wherein the filtration of the target pixel comprises weighting the value of the target pixel and the values of the surrounding pixels according to the filter coefficient set to obtain a filtered pixel.

8. The method as claimed in claim 6, wherein the target interval is selected from (N+1) intervals delimited by the N reference values.

9. The method as claimed in claim 6, wherein the determination of the filter coefficient set comprises generating a selection value to determine the filter coefficient set, wherein the selection value is derived from N bit values.

10. The method as claimed in claim 9, wherein the N bit values are obtained by comparing the accumulation value with the N reference values.
